(19) United States
(12) Patent Application Publication
(10) Pub. No.: US 2024/0411037 A1
(43) Pub. Date: Dec. 12, 2024

(54) METHOD FOR SEPARATION AND SIMULTANEOUS IMAGING OF PRIMARY AND MULTIPLE WAVES BASED ON WAVE FIELD DECOMPOSITION

(71) Applicant: Chengdu University of Technology, Chengdu (CN)

(72) Inventors: Jiachun You, Chengdu (CN); Qiang Ren, Chengdu (CN)

(21) Appl. No.: 18/642,664

(22) Filed: Apr. 22, 2024

(30) Foreign Application Priority Data
May 29, 2023 (CN) 202310616093.X

(51) Int. Cl. G01V 1/30; G01V 1/28; G01V 1/34

(52) U.S. Cl. CPC G01V 1/30; G01V 1/282; G01V 1/345

(57) ABSTRACT

A method for separation and simultaneously imaging of primary and multiple waves based on wave field decomposition is provided. It reformulates the two-way wave equation based wave field decomposition scheme to achieve efficient separation of primary wave and multiple waves of different orders, eliminate crosstalk noise, and simultaneously achieve efficient imaging of primary and multiple waves. The method is to decompose the up-going wave field into primary and up-going multiple waves of different orders on the acquisition surface, and decompose the down-going wave field into down-going multiple waves of different orders. Based on this generalized decomposition of up-going/down-going wave fields, a reformulated two-way wave equation wave field depth extrapolation scheme is used for simultaneous depth extrapolation and imaging of primary wave and multiple waves of different orders. With only one calculation, efficient imaging of multiple wave field types can be achieved.

### CROSS-REFERENCE TO RELATED APPLICATIONS

This application claims priority of Chinese Patent Application No. 202310616093.X, filed on May 29, 2023, the entire contents of which are incorporated herein by reference.

### TECHNICAL FIELD

The present disclosure relates to the field of seismic signal processing technology, in particular to a method for separation and simultaneous imaging of primary and multiple waves based on wave field decomposition.

### BACKGROUND

Regarding the separation and imaging of primary and multiple waves in seismic signal processing technology:

In existing technologies, for the separation and imaging methods of primary and multiple waves, in general, when multiple waves of different orders are separately migrated, it requires multiple migration calculations, leading to significantly increase the computational cost. This poses a challenge for depth migration based on the two-way wave equation. In response to the two challenges commonly faced in multiple wave migration: crosstalk artifact interference and increased computational cost. The present disclosure is using the two-way wave equation based the wave field extrapolation of to achieve efficient separation imaging of primary and multiple waves of different orders.

### SUMMARY

The objective of the present disclosure is to provide a method for separating and simultaneously imaging of primary and multiple waves based on wave field decomposition. By improving the two-way wave equation based wave field depth extrapolation scheme, imaging of primary and multiple waves of different orders can be completed simultaneously with very limited computational cost and high efficiency.

To achieve the above technical objective and achieve the above technical effect, the present disclosure is realized through the following technical solutions:

The first objective of the present disclosure is to provide a two-way wave equation based wave field depth extrapolation method, wherein the method is as follows:

The two-way wave equation based wave field depth extrapolation method is as follows:

In a frequency space domain, a two-dimensional acoustic wave equation is expressed as:

$$( \frac{{\partial }^{2}}{\partial {x}^{2}} + \frac{{\partial }^{2}}{\partial {z}^{2}} + \frac{{ω}^{2}}{{v}^{2} ( x , z )} ) \tilde{p} ( x , z , ω ) = 0 \qquad ( 1 )$$

Wherein, \tilde{p}(x, [symbol] ,ω) denotes a pressure wave field, ω denotes angular frequency, x and [symbol] denote horizontal spatial coordinates and vertical spatial coordinates, respectively; ν(x, [symbol] ) denotes a two-dimensional velocity model.

Defining and applying two boundary conditions defined at an initial depth [symbol] = [symbol] ₀; usually using the \tilde{p}(x, [symbol] ,ω) and the derivatives \tilde{p} [symbol] (x, [symbol] ,ω) as boundary conditions for the equation (1); and a two-way wave equation based depth extrapolation scheme the from the [symbol] = [symbol] ₀ is expressed in a matrix-vector form as following:

$$[ \begin{matrix}\tilde{p} ( x , z + Δ z , ω \\ {\tilde{p}}_{z} ( x , z + Δ z , ω\end{matrix} ] = [ \begin{matrix}cos ( {k}_{z} Δ z ) & \frac{sin ( {k}_{z} Δ z )}{k} \\ - {k}_{2} sin ( {k}_{z} Δ z ) & cos ( {k}_{z} Δ z )\end{matrix} ] [ \begin{matrix}\tilde{p} ( x , z , ω ) \\ {\tilde{p}}_{z} ( x , z , ω )\end{matrix} ] \qquad ( 2 )$$

Wherein,

$${k}_{z} = \sqrt{\frac{{\partial }^{2}}{\partial {x}^{2}} + \frac{{ω}^{2}}{{v}^{2} ( x )}}$$

represents a vertical wavenumber, [symbol] represents a depth, and Δ [symbol] represents an extrapolation depth. This equation utilizes the wave field at depth z and its derivatives to achieve layer by layer depth extrapolation calculation of the wave field, which is the foundation of the two-way wave equation wave field depth migration.

Introducing a pressure wave field \tilde{q}(x, [symbol] ,ω) to replace a pressure wave field derivative in the equation (2); the definition of parameters \tilde{q}(x, [symbol] ,ω) is:

$$\tilde{q} ( x , z , ω ) = \frac{\tilde{p} ( x , z , ω )}{I {k}_{z}} \qquad ( 3 )$$

Wherein, I is an imaginary unit. This equation describes the mathematical relationship between pressure wave field \tilde{q}(x, [symbol] ,ω) and wave field derivative \tilde{p} [symbol] (x, [symbol] ,ω), mainly solving numerical calculation problems of pressure wave field \tilde{q}(x, [symbol] ,ω).

In addition, in actual multi-component data acquisition system, a vertical component of velocity ν [symbol] (x, [symbol] ,ω) is usually able to be recorded, based on the vertical component of velocity, the following formula is used to calculate the wave field \tilde{q}(x, [symbol] ,ω).

$$\tilde{q} ( x , z , ω ) = ρ \frac{ω}{{k}_{z}} {v}_{z} ( x , z , ω ) \qquad ( 4 )$$

Wherein, I is an imaginary unit. This equation describes the mathematical relationship between the pressure wave field \tilde{q}(x, [symbol] ,ω) and the vertical component of velocity ν [symbol] (x, [symbol] ,ω), mainly solving numerical calculation problems of pressure wave field \tilde{q}(x, [symbol] ,ω) from another perspective.

Through introducing the pressure wave field \tilde{q}(x, [symbol] ,ω), the matrix-vector form in the equation (2) can be reformatted as follows:

$$[ \begin{matrix}\tilde{p} ( x , z + Δ z , ω \\ \tilde{q} ( x , z + Δ z , ω\end{matrix} ] = [ \begin{matrix}cos y & I sin y \\ I sin y & cos y\end{matrix} ] [ \begin{matrix}\tilde{p} ( x , z , ω ) \\ \tilde{q} ( x , z , ω )\end{matrix} ] \qquad ( 5 )$$

The objective of the equation (5) is to make the original depth extrapolation calculation method of the wave field easier by introducing a pressure wave field \tilde{q}(x, [symbol] ,ω). Compared with the equation (2), the reformatted matrix-vector scheme form in the equation (5) makes the separation of the up-going wave field and the down-going wave field easier, and is capable of being efficiently calculated through addition and subtraction:

$${\tilde{p}}_{d} ( x , z , ω ) = \frac{1}{2} ( \tilde{p} ( x , z , ω ) + \tilde{q} ( x , z , ω ) ) \qquad ( 6 )$$

$${\tilde{p}}_{u} ( x , z , ω ) = \frac{1}{2} ( \tilde{p} ( x , z , ω ) - \tilde{q} ( x , z , ω ) )$$

Wherein, and \tilde{p}ᵤ(x, [symbol] ,ω) and \tilde{p}_{d}(x, [symbol] ,ω) respectively represent the up-going wave field and the down-going wave field; the equation (6) achieves efficient wave field separation during the process of wave field depth extrapolation through simple addition and subtraction operations.

Thus, dual pressure wave fields \tilde{p}(x, [symbol] ,ω) and \tilde{q}(x, [symbol] ,ω) are able to be efficiently completed through calculations similar to the equation (6), as follows:

$$\tilde{p} ( x , z , ω ) = {\tilde{p}}_{d} ( x , z , ω ) + {\tilde{p}}_{u} ( x , z , ω ) \qquad ( 7 )$$

$$\tilde{q} ( x , z , ω ) = {\tilde{p}}_{d} ( x , z , ω ) - {\tilde{p}}_{u} ( x , z , ω ) .$$

the equation (7) describes the relationship between the up-going and down-going wave fields and the dual pressure wave field, providing a theoretical basis for achieving fast wave field decomposition.

Another objective of the present disclosure is to provide a method for separation of generalized primary and multiple waves based on depth extrapolation method of two-way wave equation, in order to solve the problem of crosstalk artifacts.

The method is:

According to propagation geometric patterns of the primary and multiple waves, a total wave field consists of two components: a downward propagating source wave field \tilde{P}_{d} and an upward propagating receiver wave field \tilde{P}ᵤ, namely a total down-going wave field and a total up-going wave field, expressed as following:

$${\tilde{p}}_{d} = {\tilde{p}}_{d}^{0} + \underbrace{{\tilde{p}}_{d}^{1} + {\tilde{p}}_{d}^{2} + … + {\tilde{p}}_{d}^{N}}_{D} \qquad ( 8 )$$

$${\tilde{p}}_{u} = {\tilde{p}}_{u}^{0} + \underbrace{{\tilde{p}}_{u}^{1} + {\tilde{p}}_{u}^{2} + … + {\tilde{p}}_{u}^{N}}_{M} \qquad ( 9 )$$

As a generalized source, the down-going wave field \tilde{P}_{d} includes two types of sources: physical seismic source \tilde{P}_{d}⁰ (or S) and seismic virtual source D; the up-going wave field \tilde{P}ᵤ includes a primary wave \tilde{P}ᵤ⁰ and a multiple wave M; \tilde{P}_{d}ⁱ and \tilde{P}ᵤⁱ denote the i-order down-going wave field and the i-order up-going wave field, respectively, wherein the order of the multiple waves i=1, 2, . . . , N; N is the order of the multiple waves. the equation (8) and the equation (9) define the relationship between up-going and down-going waves of different orders, which is the basis for conducting multiple wave decomposition of different orders.

From the equation (8) and the equation (9), it can be concluded that:

$${\tilde{p}}_{d} = S + D \qquad ( 10 )$$

$${\tilde{p}}_{u} = {\tilde{p}}_{u}^{0} + M \qquad ( 11 )$$

Wherein:

$$D = {\tilde{p}}_{d}^{1} + {\tilde{p}}_{d}^{2} + … + {\tilde{p}}_{d}^{N} \qquad ( 12 )$$

$$M = {\tilde{p}}_{u}^{1} + {\tilde{p}}_{u}^{2} + … + {\tilde{p}}_{u}^{N} \qquad ( 13 )$$

Wherein, S is a physical seismic source \tilde{P}_{d}⁰, D is the total down-going wavefields of different order, and M is the total up-going wavefields of different order;

If cross-correction imaging conditions are directly applied to the up-going wave field and down-going wave field, the obtained imaging not only contains true migration information required, but also unwanted crosstalk noise.

$${\sum }_{ω} {\tilde{p}}_{d} {\tilde{p}}_{u} = {\sum }_{ω} {\tilde{p}}_{d}^{i} {\tilde{p}}_{u}^{i} + {\sum }_{ω} {\tilde{p}}_{d}^{i} {\tilde{p}}_{u}^{j} ( i , j = 1.2 . ... , N ( i \neq j ) ) \qquad ( 14 )$$

Wherein, the first term and the second term of the equation on the right correspond to the true migration imaging results and the crosstalk noise imaging results, respectively. This equation explains the principle of generating crosstalk noise using cross-correlation imaging conditions for seismic data containing multiple waves of different orders. In response to the problem of crosstalk noise in conventional cross-correlation imaging, the present disclosure decomposes the up-going wave field \tilde{P}ᵤ into a primary wave \tilde{P}ᵤ⁰ and multiple waves of different orders on the acquisition surface, and decomposes the down-going wave field \tilde{P}_{d} into a primary wave and seismic virtual sources of multiple waves of different orders.

Based on the separation of up-going wave field \tilde{P}ᵤ and down-going wave field \tilde{P}_{d}, the depth extrapolation method of the two-way wave equation is used for simultaneous depth extrapolation and imaging of primary waves and multiple waves of different orders, avoiding crosstalk noise in imaging. With only one calculation, efficient simultaneous imaging of primary and multiple waves can be achieved.

Further, decomposing the up-going wave field \tilde{P}ᵤ and the down-going wave field \tilde{P}_{d} into the multiple waves of different orders, assuming that the seismic source wave field \tilde{P}_{d}⁰(S) is known, and following up-down separation, applying two pressure parameters \tilde{p} and \tilde{q} or equivalent the up-going wave field \tilde{P}ᵤ and the down-going wave field \tilde{P}_{d}.

Wherein, the separation of the up-going wave field \tilde{P}ᵤ starts from the relationship between the source S, the earth response G, and the multiple waves D reflected from the sea surface:

$$\tilde{{p}_{u}} = G \cdot {\tilde{p}}_{d} = G ( S + D ) = {\tilde{p}}_{u}^{0} + M \qquad ( 15 )$$

Wherein:

$${\tilde{p}}_{u}^{0} = G \cdot S \qquad ( 16 )$$

$$M = G \cdot D \qquad ( 17 )$$

From the equations (12), (13), and (17), it can be concluded that:

$${\tilde{p}}_{u}^{i} = G \cdot {\tilde{p}}_{d}^{i} ( i \geq 1 ) \qquad ( 18 )$$

G is the earth response, as seen from equations 15-18, G is represented by one of the following four equations:

$$G = \frac{{\tilde{p}}_{u}}{{\tilde{p}}_{d}} , G = \frac{{\tilde{p}}_{u}^{0}}{{\tilde{p}}_{d}^{0}} , G = \frac{M}{D} , or G = \frac{{\tilde{p}}_{u}^{i}}{{\tilde{p}}_{d}^{i}} ( i \geq 1 ) \qquad ( 19 )$$

Using the first formula of the equation (19) and the equation (16), the relationship between \tilde{p}ᵤ⁰ and \tilde{p}ᵤ can be obtained as follows:

$$G = \frac{{\tilde{p}}_{u}}{S + D} = \frac{{\tilde{p}}_{u}}{S ( 1 + \frac{D}{S} )} \qquad ( 20 )$$

$${\tilde{p}}_{u}^{0} = G \cdot S = \frac{{\tilde{p}}_{u}}{1 + \frac{D}{S}} = \frac{{\tilde{p}}_{u}}{1 + {D}^{′}} \qquad ( 21 )$$

Wherein:

$${D}^{′} = \frac{D}{S} = A \cdot D \qquad ( 22 )$$

$$A = \frac{1}{S} \qquad ( 23 )$$

D′ mentioned above denotes the down-going wave after deconvolution, and A denotes source characteristics in a frequency domain.

In order to decompose the up-going wave field \tilde{P}ᵤ into a primary wave and the up-going multiple waves of different orders, the right side of the equation (21) is expanded in series:

$${\tilde{p}}_{u}^{0} = {\tilde{p}}_{u} - {D}^{′} \cdot {\tilde{p}}_{u} + {D}^{′2} \cdot {\tilde{p}}_{u} + … + {( - 1 )}^{N} {D}^{′ N} \cdot {\tilde{p}}_{u} \qquad ( 24 )$$

$$M = {\tilde{p}}_{u} - {\tilde{p}}_{u}^{0} = {D}^{′} \cdot {\tilde{p}}_{u} - {D}^{′2} \cdot {\tilde{p}}_{u} + … + {( - 1 )}^{N - 1} {D}^{′ N} \cdot {\tilde{p}}_{u} \qquad ( 25 )$$

Wherein, N is the order of multiple waves.

The relationship between \tilde{P}ᵤ and \tilde{P}ᵤ⁰ expressed in the equations (24) and (25) is proven to be equivalent to other methods derived solely from the up-going wave field \tilde{P}ᵤ.

The main advantage of using two boundary conditions applied to the acquisition surface is that, a free surface reflection operator is not required, which is implicit in the decomposition of the up-going wave field and the down-going wave field.

Simplifying the equation (25) above to obtain:

$$M = {C}_{1} + {C}_{2} + {C}_{3} + … + {C}_{i} \qquad ( 26 )$$

Wherein: C₁, . . . , Cᵢ corresponds to each term on the far right of the equation (25), namely:

$${C}_{1} = {D}^{′} \cdot {\tilde{p}}_{u} , {C}_{2} = {D}^{′2} \cdot {\tilde{p}}_{u} , {C}_{3} = {D}^{′3} \cdot {\tilde{p}}_{u} , … , {C}_{i} = {( - 1 )}^{N - 1} {D}^{′ N} \cdot {\tilde{p}}_{u}$$

By using the equations (15)-(26), this disclosure elaborates in detail on decomposing the up-going wave field into up-going multiples of different orders, solving the problem of decomposing multiples of different orders in the up-going wave field.

Wherein, the separation of the down-going wave field \tilde{P}_{d}.

Once the \tilde{P}ᵤ is decomposed into a primary wave and up-going multiple waves of different orders, the down-going wave field \tilde{P}_{d} is correspondingly decomposed into a plurality of virtual seismic sources.

Using the equations (20) and (26), the first-order down-going wave field and the higher-order down-going wave field are obtained as follows:

$$\begin{matrix}{\tilde{p}}_{d}^{1} = \frac{{\tilde{p}}_{d}}{1 + {D}^{′}} \\ = {\tilde{p}}_{d} - [ {D}^{′} \cdot {\tilde{p}}_{d} - {D}^{′2} \cdot {\tilde{p}}_{d} + {D}^{′3} \cdot {\tilde{p}}_{d} + … {( - 1 )}^{N - 1} {D}^{′ N} \cdot {\tilde{p}}_{d} ] \\ = {\tilde{p}}_{d} - ( {K}_{1} + {K}_{2} + {K}_{3} + … + {K}_{i} )\end{matrix} \qquad ( 28 )$$

Wherein: K₁, . . . , Kᵢ corresponds to each term on the right side of the second row of the equation (28), namely:

$${K}_{1} = {D}^{′} \cdot {\tilde{p}}_{u} , {K}_{2} = - {D}^{′2} \cdot {\tilde{p}}_{u} , {K}_{3} = {D}^{′3} \cdot {\tilde{p}}_{u} , … , {K}_{i} = {( - 1 )}^{N - 1} {D}^{′ N} \cdot {\tilde{p}}_{u} \qquad ( 29 )$$

The down-going wave field is decomposed into \tilde{P}_{d}ⁱ (i=1, 2, . . . , N), expressed as: Kᵢ (i=1, 2, . . . , N); for N=3, the relationship between \tilde{P}_{d}ⁱ and Kᵢ is as follows:

$${\tilde{p}}_{d}^{1} = {K}_{1} + 2 {K}_{2} + 3 {K}_{3} , {\tilde{p}}_{d}^{2} = - {K}_{2} - 3 {K}_{3} , {\tilde{p}}_{d}^{3} = {K}_{3} \qquad ( 30 )$$

Using the equation (30), the calculation of \tilde{P}_{d}², \tilde{P}_{d}³ and \tilde{P}_{d}⁴ is completed through simple operations of K₁, K₂ and K₃, while the values of K₁, K₂ and K₃ are obtained from the equations (28) and (29).

Based on above process, the up-going wave field is decomposed into a primary wave and up-going multiple waves of different orders, and the down-going wave field is decomposed into virtual seismic sources of different orders.

By using the equations (28)-(30), this disclosure elaborates in detail on decomposing the down-going wave field into down-going multiple waves of different orders, solving the problem of decomposing multiple waves of different orders in the down-going wave field.
the equations (15)-(30) solve the problem of different order multiple wave decomposition in the up-going wave field and the down-going wave field. When using the equation (14) for cross-correlation imaging, the objective of solving crosstalk noise in imaging can be achieved.

Another objective of the present disclosure is to provided the method for separation of the generalized primary and multiple waves, which is capable to simultaneously achieve imaging of primary waves and multiple waves of different orders with very limited computational cost and high efficiency, and this method includes four steps: reconstruction, extrapolation, separation, and imaging.

Specifically, the method includes:

The reconstruction is as follows:

Reconstructing data into a two-way wave pressure wave fields (\tilde{p}ᵢ,\tilde{q}ᵢ)

Firstly, recombining and reconstructing the separated up-going wave field and the down-going wave field: using the equation (6) to reconstruct \tilde{p}_{d}ⁱ (i=1, 2, . . . , N+1) and \tilde{p}ᵤⁱ (i=1, 2, . . . , N) into relevant two-way wave pressure wave fields \tilde{p}ᵢ,\tilde{q}ᵢ (i=1, 2, . . . , N) on the acquisition surface:

$${\tilde{p}}_{i} = {\tilde{p}}_{d}^{i} + {\tilde{p}}_{u}^{i - 1} {\tilde{q}}_{i} = {\tilde{p}}_{d}^{i} - {\tilde{p}}_{u}^{i - 1} ( i = 1 , 2 , … , N + 1 ) \qquad ( 31 )$$

The objective of this equation is to reconstruct the dual pressure wave field using decomposed multiple waves of different orders, in order to prepare data for the depth extrapolation wave field of the two-way wave equation.

Extrapolation of primary waves and multiple waves of different orders (\tilde{p}ⱼ,\tilde{q}ⱼ).

The two-way wave pressure wave fields (\acute{p}ᵢ,\acute{q}ᵢ) (i=1, 2, . . . , N+1) after reconstruction is conducted depth extrapolation using the same two-way wave propagation matrix (as described in equation 4), wherein the one-dimensional vectors \tilde{p} and \tilde{q} in equation 4 are extended into multidimensional vector (matrix): (\tilde{p}ⱼ,\tilde{q}ⱼ), wherein j=1, 2, . . . , N+1.

The extended matrix-vector form is represented as follows:

$$[ \begin{matrix}{\tilde{p}}_{1} ( x , z + Δ z , ω ) & … {\tilde{p}}_{j} ( x , z + Δ z , ω ) … & {\tilde{p}}_{N} ( x , z + Δ z , ω ) \\ {\tilde{q}}_{1} ( x , z + Δ z , ω ) & … {\tilde{q}}_{j} ( x , z + Δ z , ω ) … & {\tilde{q}}_{N} ( x , z + Δ z , ω )\end{matrix} ] = \text{} [ \text{} \begin{matrix}cos y & I sin y \\ I sin y & cos y\end{matrix} ] [ \begin{matrix}{\tilde{p}}_{1} ( x , z , ω ) & … {\tilde{p}}_{j} ( x , z , ω ) … & {\tilde{p}}_{N} ( x , z , ω ) \\ {\tilde{q}}_{1} ( x , z , ω ) & … {\tilde{q}}_{j} ( x , z , ω ) … & {\tilde{q}}_{N} ( x , z , ω )\end{matrix} ] \qquad ( 32 )$$

In the equation (32), I is an imaginary unit.

It should be noted that according to the exponential definition of \tilde{p}ᵤ and \tilde{p}_{d}, in the case of j=1, the depth extrapolation of the two-way wave pressure wave fields (\tilde{p}₁,\tilde{q}₁) is a conventional method of depth extrapolation. Due to the fact that the calculation of the two-way wave propagation matrix accounts for the largest proportion of the computational cost in depth extrapolation, the additional computational cost of matrix-vector for multiple waves (j=1, 2, . . . , N) is limited. This equation realizes the simultaneous depth extrapolation calculation of multiple waves of different orders, achieving the effect of saving calculation time and improving calculation efficiency.

The separation is as follows:

Decomposing the two-way wave pressure wave fields (\tilde{p}ᵢ,\tilde{q}ᵢ) into primary waves and multiple waves of different orders in each depth extrapolation step; using the equation (5) to decompose the two-way wave pressure wave field (\tilde{p}ᵢ,\tilde{q}ᵢ) (i=1, 2, . . . , N+1) (i=1, 2, . . . , N+1) after depth extrapolation into:

$${\tilde{p}}_{d}^{i} = \frac{1}{2} ( {\tilde{p}}_{i} + {\tilde{q}}_{i} ) {\tilde{p}}_{u}^{i - 1} = \frac{1}{2} ( {\tilde{p}}_{i} - {\tilde{q}}_{i} ) ( i = 1 , 2 , … , N + 1 ) \qquad ( 33 )$$

It should be noted that the separation of the up-going wave field/the down-going wave field represented by equation 31 is very efficient, only simple summation and subtraction operations are required, so the additional calculations involved in this processing process (involving multidimensional vectors) can be ignored. This equation decomposes the dual pressure wave field that conduct extrapolation computation into different orders of up-going and down-going waves, preparing data for imaging using cross-correlation imaging conditions.

Imaging of the primary waves and the multiple waves of different orders.

Using the decomposed (\tilde{p}_{d}ⁱ,\tilde{p}ᵤⁱ⁻¹) (i=1, 2, . . . , N+1) for imaging of primary waves and multiple waves in a controllable manner:

$${I}_{0} = S * {\tilde{p}}_{u}^{0} {I}_{i} = {\tilde{p}}_{d}^{i} * {\tilde{p}}_{u}^{i} ( i = 1 , 2 , … , N ) {I}_{m} = {\sum }_{i} {I}_{i} ( i = 1 , 2 , … , N ) \qquad ( 34 )$$

Wherein “*” represents cross-correlation operation (time domain) or multiplication operation (frequency domain); S represents physical seismic source; I₀ is the imaging of the primary waves, similar to traditional imaging, which requires conducting the source wave field extrapolation; Iᵢ is the imaging of multiple waves of different orders; and Iₘ is an imaging of a total of N-order multiple waves. This equation separately images different orders of up-going and down-going waves for decomposition, achieving the technical effect of avoiding crosstalk noise.

From the above description, it can be seen that using the provided method and scheme, the additional computational cost caused by multiple wave migration is very limited. When the highest order N is small (for the numerical experiment N≤3 of the present disclosure), the provided method can efficiently complete the migration of primary waves and multiple waves of different orders simultaneously, with almost the same efficiency as the imaging of primary waves. This method has been verified through numerical examples in the embodiment.

The present disclosure further discloses a separation and imaging device for separation and imaging of primary and multiple waves based on wave field decomposition. The device uses a built-in program to complete the above processing method. The acquisition surface decomposes the up-going wave field into primary waves and multiple waves of different orders, and decomposes the down-going received wave field into seismic virtual sources of the multiple waves of different orders. With only one calculation, efficient imaging can be achieved.

The advantageous effects of the present disclosure are shown as below:

A method for separation and simultaneous imaging of primary and multiple waves based on wave field decomposition is provided, and achieve efficient separation of primary waves and multiple waves of different orders by improving the wave field depth extrapolation scheme of the two-way wave equation.

The method provided by the present disclosure aims to eliminate or reduce the interference of crosstalk noise and achieve efficient imaging of multiple waves at the same time. The method involves decomposing the up-going wave field into a primary wave and multiple waves of different orders on the acquisition surface, and decomposing the down-going received wave field into seismic virtual sources of the multiple waves of different orders. Based on this generalized up-going/down-going wave field separation foundation, an improved wave field depth extrapolation scheme of the two-way wave equation is used for simultaneous depth extrapolation and imaging of primary waves and multiple waves of different orders, with only one calculation, efficient imaging can be achieved. By using of the provided method and solution, the additional computational cost caused by imaging of the multiple waves is very limited. When the highest order N is small (for the numerical experiment of the present disclosure, N≤3), the provided method can efficiently image both primary and multiple waves of different orders simultaneously, with almost the same efficiency as primary wave imaging.

Of course, implementing any product of the present disclosure does not necessarily require achieving all the advantages described above at the same time.

### BRIEF DESCRIPTION OF THE DRAWINGS

FIG. 1 shows the propagation geometric pattern of the primary and multiple waves described in an embodiment of the present disclosure, including two components: a downward propagating wave field and an upward propagating wave field;

FIG. 2 shows a velocity model with a single horizontal interface;

FIG. 3a is a schematic diagram of wave field P;

FIG. 3b is a schematic diagram of wave field Q;

FIG. 3c is a schematic diagram of wave field PD;

FIG. 3d is a schematic diagram of wave field PU;

FIG. 3e is a schematic diagram of multiple wave propagation, wherein up-going wave field of single wave reflection and multiple wave reflection, down-going wave field of physical seismic source and multiple wave seismic virtual source;

FIG. 4a shows the separated up-going wave field and down-going wave field of different orders of primary wave field;

FIG. 4b shows the separated up-going wave field and down-going wave field of different orders of first order up-going wave field (multiple waves);

FIG. 4c shows the separated up-going wave field and down-going wave field of different orders of second order up-going wave field (multiple waves);

FIG. 4d shows the separated up-going wave field and down-going wave field of different orders of first order down-going wave field (seismic virtual source);

FIG. 4e shows the separated up-going wave field and down-going wave field of different orders of second order down-going wave field (seismic virtual source);

FIG. 4f shows the separated up-going wave field and down-going wave field of different orders of third order down-going wave field (seismic virtual source);

FIG. 5a shows the imaging results of the double-layer model of a complete wave field without wave field separation;

FIG. 5b shows the imaging results of the double-layer model of a primary wave field;

FIG. 5c shows the imaging results of the double-layer model of first order multiple waves;

FIG. 5d shows the imaging results of the double-layer model of second order multiple waves;

FIG. 6a shows an original velocity model;

FIG. 6b shows a smoothed velocity model;

FIG. 7a shows a shot gather with a free surface;

FIG. 7b shows the separated shot gather;

FIG. 7c shows a shot gather generated based on a complete absorption layer;

FIG. 8a shows that the imaging part uses a simulated wave field with a free surface;

FIG. 8b shows the separated primary wave field obtained according to the provided scheme;

FIG. 8c shows a simulated wave field with complete absorption layer.

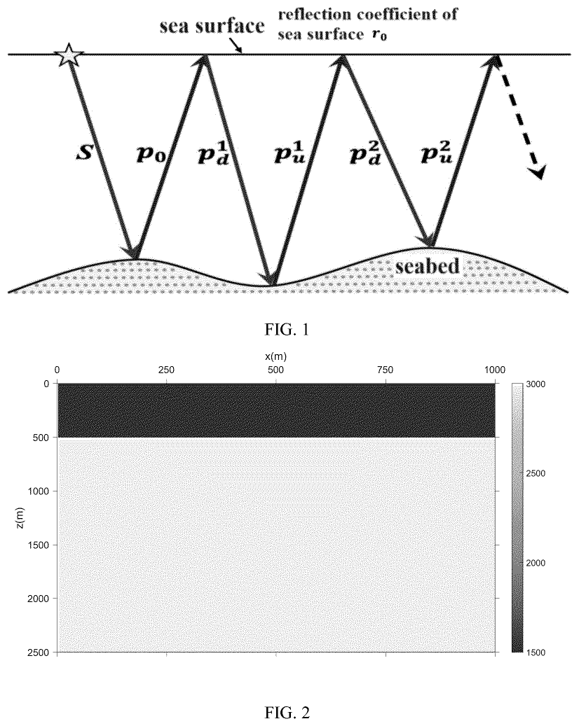

### DETAILED DESCRIPTION OF THE EMBODIMENTS

In order to provide a clearer explanation of the technical solution of the embodiments of the present disclosure, the following will provide a detailed illustration of the embodiments in conjunction with the accompanying drawings.

### Embodiment 1

In the present embodiment, the present disclosure is to provide a wave field depth extrapolation method of two-way wave equation, wherein the method is as follows: The wave field depth extrapolation method of the two-way wave equation is as follows: In a frequency space domain, a two-dimensional acoustic wave equation is expressed as:

$$( \frac{{\partial }^{2}}{\partial {x}^{2}} + \frac{{\partial }^{2}}{\partial {z}^{2}} + \frac{c {o}^{2}}{{v}^{2} ( x , z )} ) \tilde{p} ( x , z , ω ) = 0 \qquad ( 1 )$$

Wherein, \tilde{p}(x, [symbol] ,ω) denotes a pressure wave field, ω denotes angular frequency, x and [symbol] denote horizontal spatial coordinates and vertical spatial coordinates, respectively; and ν(x, [symbol] ) denotes a two-dimensional velocity model.

Defining and applying two boundary conditions defined at an initial depth [symbol] = [symbol] ₀; usually using the \tilde{p}(x, [symbol] ,ω) and the derivatives \tilde{p}_{z}(x, [symbol] ,ω) as boundary conditions for the equation (1); and a two-way wave equation based depth extrapolation scheme from the [symbol] = [symbol] ₀ is expressed in a matrix-vector form as following:

$$[ \begin{matrix}\tilde{p} ( x , z + Δ z , ω ) \\ {\tilde{p}}_{z} ( x , z + Δ z , ω )\end{matrix} ] = [ \begin{matrix}cos ( {k}_{z} Δ z ) & \frac{sin ( {k}_{z} Δ z )}{{k}_{z}} \\ - {k}_{z} sin ( {k}_{z} Δ z ) & cos ( {k}_{z} Δ z )\end{matrix} ] [ \begin{matrix}\tilde{p} ( x , z , ω ) \\ \tilde{{p}_{z}} ( x , z , ω )\end{matrix} ] \qquad ( 2 )$$

Wherein,

$${k}_{z} = \sqrt{\frac{{\partial }^{2}}{\partial {x}^{2}} + \frac{{ω}^{2}}{{v}^{2} ( x )}}$$

represents a vertical wavenumber, [symbol] represents a depth, and Δz represents an extrapolation depth.

Introducing a pressure wave field \tilde{q}(x, [symbol] ,ω) to replace a pressure wave field derivative in the equation (2), and the definition of parameters \tilde{q}(x, [symbol] ,ω) is:

$$\tilde{q} ( x , z , ω ) = \frac{\tilde{p} ( x , z , ω )}{I {k}_{z}} \qquad ( 3 )$$

Wherein, I is an imaginary unit.

In addition, in actual multi-component data acquisition system, a vertical component of velocity ν_{z}(x, [symbol] ,ω) can be usually recorded, based on the vertical component of velocity, the following formula is used to calculate the wave field \tilde{q}(x, [symbol] ,ω).

$$\tilde{q} ( x , z , ω ) = ρ \frac{ω}{{k}_{z}} {v}_{z} ( x , z , ω ) \qquad ( 4 )$$

Wherein, ρ is the medium density.

The matrix-vector form in the equation (2) can be reformatted as follows:

$$[ \begin{matrix}\tilde{p} ( x , z + Δ z , ω ) \\ \tilde{q} ( x , z + Δ z , ω )\end{matrix} ] = [ \begin{matrix}cos y & I sin y \\ I sin y & cos y\end{matrix} ] [ \begin{matrix}\tilde{p} ( x , z , ω ) \\ \tilde{q} ( x , z , ω )\end{matrix} ] \qquad ( 5 )$$

Wherein, I is an imaginary unit. Compared with the equation (2), the reformatted matrix-vector scheme form in the equation (5) makes the separation of the up-going wave field and the down-going wave field easier, and is capable of being efficiently calculated through addition and subtraction:

$${\tilde{p}}_{d} ( x , z , ω ) = \frac{1}{2} ( \tilde{p} ( x , z , ω ) + \tilde{q} ( x , z , ω ) ) {\tilde{p}}_{u} ( x , z , ω ) = \frac{1}{2} ( \tilde{p} ( x , z , ω ) - \tilde{q} ( x , z , ω ) ) \qquad ( 6 )$$

Wherein, \tilde{p}ᵤ(x, [symbol] ,ω) and \tilde{p}_{d}(x, [symbol] ,ω) respectively represent the up-going wave field and the down-going wave field;

Thus, dual pressure wave fields \tilde{p}(x, [symbol] ,ω) and \tilde{q}(x, [symbol] ,ω) can be efficiently completed through calculations similar to the equation (6), as follows:

$$\tilde{p} ( x , z , ω ) = {\tilde{p}}_{d} ( x , z , ω ) + {\tilde{p}}_{u} ( x , z , ω ) \\ \tilde{q} ( x , z , ω ) = {\tilde{p}}_{d} ( x , z , ω ) - {\tilde{p}}_{u} ( x , z , ω ) . \qquad ( 7 )$$

### Embodiment 2

In this embodiment, the following embodiments are provided based on the above embodiments:

The present disclosure is to provide a method for separation of generalized primary and multiple waves based on depth extrapolation method of two-way wave equation, in order to solve the problem of crosstalk artifacts. The method is: According to propagation geometric patterns of the primary and multiple waves, a total wave field consists of two components: a downward propagating source wave field \tilde{P}_{d} and an upward propagating receiver wave field \tilde{P}ᵤ, namely a total down-going wave field and a total up-going wave field, expressed as following:

$${\tilde{p}}_{d} = {\tilde{p}}_{d}^{0} + {\underbrace{{\tilde{p}}_{d}^{1} + {\tilde{p}}_{d}^{2} + … + {\tilde{p}}_{d}^{N}}}_{D} \qquad ( 8 )$$

$${\tilde{p}}_{u} = {\tilde{p}}_{u}^{0} + {\underbrace{{\tilde{p}}_{u}^{1} + {\tilde{p}}_{u}^{2} + … + {\tilde{p}}_{u}^{N}}}_{M} \qquad ( 9 )$$

As a generalized source, the down-going wave field \tilde{P}_{d} includes two types of sources: physical seismic source \tilde{P}_{d}⁰ (or S) and seismic virtual source D; the up-going wave field \tilde{P}ᵤ includes a primary wave \tilde{P}ᵤ⁰ and a multiple wave M; \tilde{P}_{d}ⁱ and \tilde{P}ᵤⁱ denote the i-order down-going wave field and the i-order up-going wave field, respectively, wherein the order of the multiple waves i=1, 2, . . . , N; N is the order of the multiple waves.

From the equation (8) and the equation (9), it can be concluded that:

$${\tilde{p}}_{d} = S + D \qquad ( 10 )$$

$${\tilde{p}}_{u} = {\tilde{p}}_{u}^{0} + M \qquad ( 11 )$$

Wherein:

$$D = {\tilde{p}}_{d}^{1} + {\tilde{p}}_{d}^{2} + … + {\tilde{p}}_{d}^{N} \qquad ( 12 )$$

$$M = {\tilde{p}}_{u}^{1} + {\tilde{p}}_{u}^{2} + … + {\tilde{p}}_{u}^{N} \qquad ( 13 )$$

Wherein, S is a physical seismic source \tilde{P}_{d}⁰, D is the total down-going wavefields of different order, and M is the total up-going wavefields of different order.

If cross-correction imaging conditions are directly applied to the up-going wave field and down-going wave field, the obtained imaging not only contains true migration information required, but also unwanted crosstalk noise.

$${\sum }_{ω} {\tilde{p}}_{d} {\tilde{p}}_{u} = {\sum }_{ω} {\tilde{p}}_{d}^{i} {\tilde{p}}_{u}^{i} + {\sum }_{ω} {\tilde{p}}_{d}^{i} {\tilde{p}}_{u}^{j} ( i , j = 1.2 . … , N ( i \neq j ) ) \qquad ( 14 )$$

Wherein, the first term and the second term of the equation on the right correspond to the true migration imaging results and the crosstalk noise imaging results, respectively.

In response to the problem of crosstalk noise in conventional cross-correlation imaging, the present disclosure decomposes the up-going wave field \tilde{P}ᵤ into primary wave \tilde{P}ᵤ⁰ and multiple waves of different orders on the acquisition surface, and decomposes the down-going wave field \tilde{P}_{d} into primary wave and seismic virtual sources of multiple waves of different orders.

Based on the separation of up-going wave field \tilde{P}ᵤ and down-going wave field \tilde{P}_{d}, the depth extrapolation method of the two-way wave equation is used for simultaneous depth extrapolation and imaging of primary wave and multiple waves of different orders, avoiding crosstalk noise in imaging. With only one calculation, efficient simultaneous imaging of primary and multiple waves can be achieved.

Further, decomposing the up-going wave field \tilde{P}ᵤ and the down-going wave field \tilde{P}_{d} into primary wave and the multiple waves of different orders, assuming that the seismic source wave field \tilde{P}_{d}⁰(S) is known, and following up-down separation, applying two pressure parameters \tilde{p} and \tilde{q} or equivalent the up-going wave field \tilde{P}ᵤ and the down-going wave field \tilde{P}_{d}.

Wherein, the separation of the up-going wave field \tilde{P}ᵤ starts from the relationship between the source S, the earth response G, and the multiple waves D reflected from the sea surface:

$${\tilde{p}}_{u} = G \cdot {\tilde{p}}_{d} = G ( S + D ) = {\tilde{p}}_{u}^{0} + M \qquad ( 15 )$$

Wherein:

$${\tilde{p}}_{u}^{0} = G \cdot S \qquad ( 16 )$$

$$M = G \cdot D \qquad ( 17 )$$

From the equations (12), (13), and (17), it can be concluded that:

$${\tilde{p}}_{u}^{i} = G \cdot {\tilde{p}}_{d}^{i} ( i \geq 1 ) \qquad ( 18 )$$

G is the earth response, as seen from equations 15-18, G is represented by one of the following four equations:

$$G = \frac{{\tilde{p}}_{u}}{{\tilde{p}}_{d}} , G = \frac{{\tilde{p}}_{u}^{0}}{{\tilde{p}}_{d}^{0}} , G = \frac{M}{D} , or G = \frac{{\tilde{p}}_{u}^{i}}{{\tilde{p}}_{d}^{i}} ( i \geq 1 ) \qquad ( 19 )$$

Using the first formula of the equation (19) and the equation (16), the relationship between \tilde{p}ᵤ⁰ and \tilde{p}ᵤ can be obtained as follows:

$$G = \frac{{\tilde{p}}_{u}}{S + D} = \frac{{\tilde{p}}_{u}}{S ( 1 + \frac{D}{S} )} \qquad ( 20 )$$

$${\tilde{p}}_{u}^{0} = G \cdot S = \frac{{\tilde{p}}_{u}}{1 + \frac{D}{S}} = \frac{{\tilde{p}}_{u}}{1 + {D}^{′}} \qquad ( 21 )$$

Wherein:

$${D}^{′} = \frac{D}{S} = A \cdot D \qquad ( 22 )$$

$$A = \frac{1}{S} \qquad ( 23 )$$

D′ mentioned above denotes the down-going wave after deconvolution, and A denotes source characteristics in a frequency domain.

In order to decompose the up-going wave field \tilde{P}ᵤ into primary wave and the up-going multiple waves of different orders, the right side of the equation (21) is expanded in series:

$${\tilde{p}}_{u}^{0} = {\tilde{p}}_{u} - {D}^{′} \cdot {\tilde{p}}_{u} + {D}^{′2} \cdot {\tilde{p}}_{u} + … + {( - 1 )}^{N} {D}^{′ N} \cdot {\tilde{p}}_{u} \qquad ( 24 )$$

$$M = {\tilde{p}}_{u} - {\tilde{p}}_{u}^{0} = {D}^{′} \cdot {\tilde{p}}_{u} - {D}^{′2} \cdot {\tilde{p}}_{u} + … + {( - 1 )}^{N - 1} {D}^{′ N} \cdot {\tilde{p}}_{u} \qquad ( 25 )$$

Wherein, N is the order of multiple waves.

The relationship between \tilde{P}ᵤ \tilde{P}ᵤ⁰ and expressed in the equations (24) and (25) is proven to be equivalent to other methods derived solely from the up-going wave field \tilde{P}ᵤ.

The main advantage of using two boundary conditions applied to the acquisition surface is that, a free surface reflection operator is not required, which is implicit in the decomposition of the up-going wave field and the down-going wave field.

Simplifying the equation (25) above to obtain:

$$M = {C}_{1} + {C}_{2} + {C}_{3} + … + {C}_{i} \qquad ( 26 )$$

Wherein: C₁, . . . , Cᵢ corresponds to each term on the far right of the equation (25), namely:

$${C}_{1} = {D}^{′} \cdot {\tilde{p}}_{u} , {C}_{2} = {D}^{′2} \cdot {\tilde{p}}_{u} , {C}_{3} = {D}^{′3} \cdot {\tilde{p}}_{u} , … , {C}_{i} = {( - 1 )}^{N - 1} {D}^{′ N} \cdot {\tilde{p}}_{u}$$

Wherein, the separation of the down-going wave field \tilde{P}_{d}:

Once the \tilde{P}ᵤ is decomposed into primary wave and up-going multiple waves of different orders, the down-going wave field \tilde{P}_{d} is correspondingly decomposed into a plurality of virtual seismic sources.

Using the equations (20) and (26), the first-order down-going wave field and the higher-order down-going wave field are obtained as follows:

$$\begin{matrix}{\tilde{p}}_{d}^{1} = \frac{{\tilde{p}}_{d}}{1 + {D}^{′}} \\ = {\tilde{p}}_{d} - [ {D}^{′} \cdot {\tilde{p}}_{d} - {D}^{′2} \cdot {\tilde{p}}_{d} + {D}^{′3} \cdot {\tilde{p}}_{d} + … {( - 1 )}^{N - 1} {D}^{′ N} \cdot {\tilde{p}}_{d} ] \\ = {\tilde{p}}_{d} - ( {K}_{1} + {K}_{2} + {K}_{3} + … + {K}_{i} )\end{matrix} \qquad ( 28 )$$

Wherein: K₁, . . . , Kᵢ corresponds to each term on the right side of the second row of the equation (28), namely:

$${K}_{1} = {D}^{′} \cdot {\tilde{p}}_{u} , {K}_{2} = - {D}^{′2} \cdot {\tilde{p}}_{u} , {K}_{3} = {D}^{′3} \cdot {\tilde{p}}_{u} , … , {K}_{i} = {( - 1 )}^{N - 1} {D}^{′ N} \cdot {\tilde{p}}_{u} \qquad ( 29 )$$

The down-going wave field is decomposed into \tilde{P}_{d}ⁱ (i=1, 2, . . . , N), expressed as: Kᵢ (i=1, 2, . . . , N); for N=3, the relationship between \tilde{P}_{d}ⁱ and Kᵢ is as follows:

$${\tilde{p}}_{d}^{1} = {K}_{1} + 2 {K}_{2} + 3 {K}_{3} , \qquad ( 30 )$$

$${\tilde{p}}_{d}^{2} = - {K}_{2} - 3 {K}_{3} ,$$

$${\tilde{p}}_{d}^{3} = {K}_{3}$$

Using the equation (30), the calculation of \tilde{P}_{d}², \tilde{P}_{d}³ and \tilde{P}_{d}⁴ is completed through simple operations of K₁, K₂ and K₃, while the values of K₁, K₂ and K₃ are obtained from the equations (28) and (29).

Based on above process, the up-going wave field is decomposed into primary wave and up-going multiple waves of different orders, and the down-going wave field is decomposed into virtual seismic sources of different orders.

### Embodiment 3

A new method for reformulated depth extrapolation scheme using the two-way wave equation is disclosed. The method can simultaneously complete the imaging of primary wave and multiple wave of different orders in a very limited computational cost and efficient manner. The method includes four steps: reconstruction, extrapolation, separation and imaging.

### Numerical Algorithm and Implementation.

The numerical implementation of the method can be summarized as the following processing steps:
1) Using the equation 5, the dual boundary data (\tilde{p},\tilde{q}) is decomposed into data (\tilde{p}_{d},\tilde{q}ᵤ) of an up-going wave field and a down-going wave field at the measurement surface [symbol] = [symbol] ₀:
2) Using the equation 26-27 and the equation 28-30 respectively, the \tilde{p}ᵤ and \tilde{p}_{d} are decomposed into primary wave and multiple wave of different orders at the measurement surface [symbol] = [symbol] ₀;
3) Using the equation 31, the decomposed primary wave \tilde{p}ᵤ and the decomposed multiple wave of different orders \acute{p}_{d} are reconstructed into (\tilde{p}ᵢ,\tilde{q}ᵢ) i=1, 2, . . . , N+1;
4) Using the equation 32, the downward extrapolation of receiver wave field (\tilde{p}ᵢ,\tilde{q}ᵢ) i=1, 2, . . . , N+1 is performed, and the same propagation matrix is used;
5) Using the equation 33, the wave fields (\tilde{p}ᵢ,\tilde{q}ᵢ) are decomposed into the wave field (\tilde{p}_{d}ⁱ,\tilde{p}ᵤⁱ⁻¹) i=1, 2, . . . , N+1 at each depth extrapolation step;
6) Applying the imaging conditions to the seismic source wave field S, accordingly, the wave field (\tilde{p}_{d}ⁱ,\tilde{p}ᵤⁱ⁻¹) i=1, 2, . . . , N+1 is separated by using the equation 34, and the imaging of the primary wave and the multiple wave of different orders is completed simultaneously at each depth extrapolation step.

In order to verify the feasibility of the provided theory and method, numerical experiments were conducted on several synthetic models in the embodiment, and the performance of the generalized up-going/down-going wave field separation and the efficiency of simultaneous imaging of the primary wave and the multiple waves of different orders were verified using a reformulated two-way wave depth extrapolation scheme. In the following numerical experiments, the finite difference technique and the free surface boundary conditions are used to simulate the synthesized shot gather of the primary wave and the multiple waves of different orders. For a fair comparison, absorbing boundary conditions are also used to generate corresponding shot gather, but only the primary wave simulation is performed.

The imaging of the primary wave and the multiple waves of a two-dimensional two-layer model with a single horizontal surface (N=2).

The embodiment establishes a two-dimensional model with a single horizontal surface, verifying the effectiveness and efficiency of the provided method in simultaneous imaging of the primary wave and the multiple wave. The velocity model is shown in FIG. 2. The size of the model is 1,000 m (z)×1,000 m (x), with a grid spacing of 5.0 m in both vertical and horizontal directions. The seismic source is a Ricker wavelet with a main frequency of 20 Hz. The maximum time length is 4.0 s and the sampling rate is 0.001 s. The physical seismic source is placed at x=500 m and z=5.0 m, while the receivers are located between x=0 m and x=1000 m, z=5.0 m, with an interval of 5.0 m.

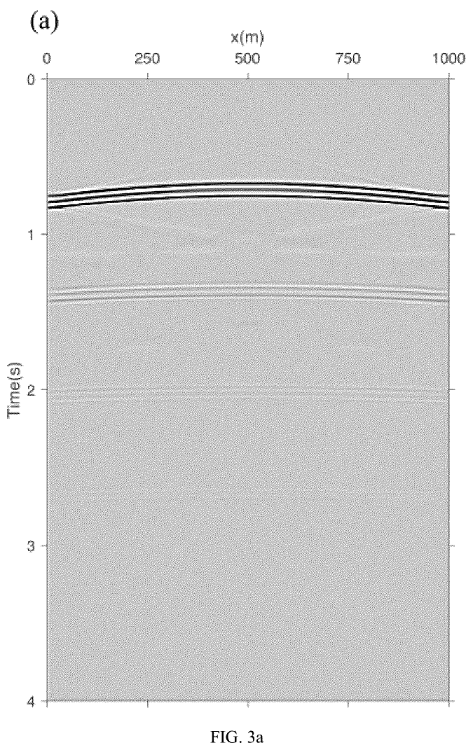

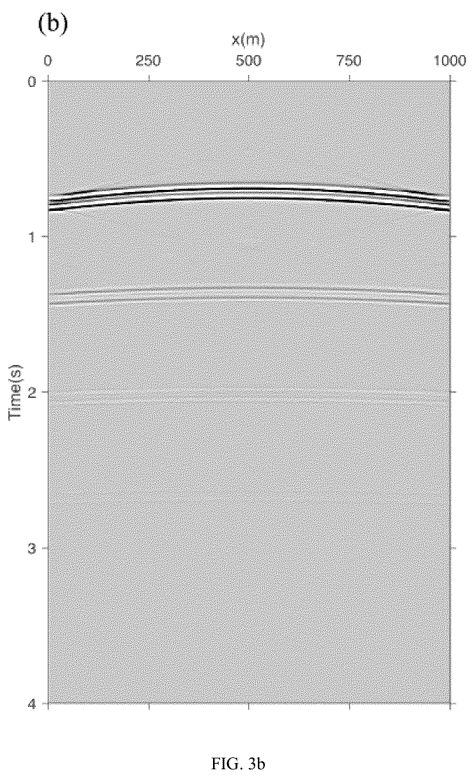

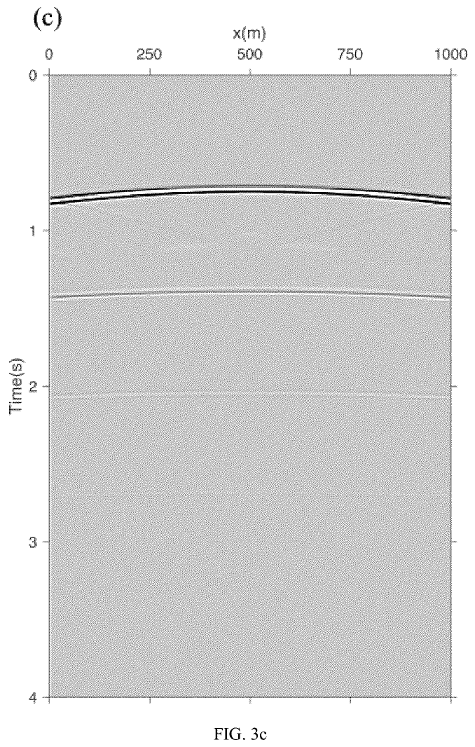

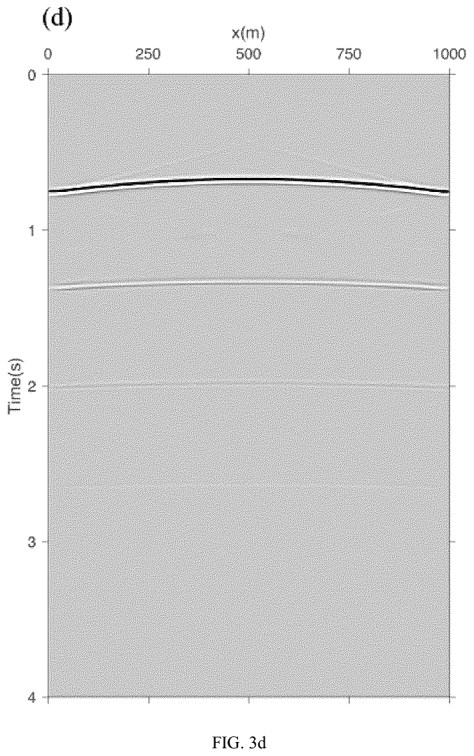

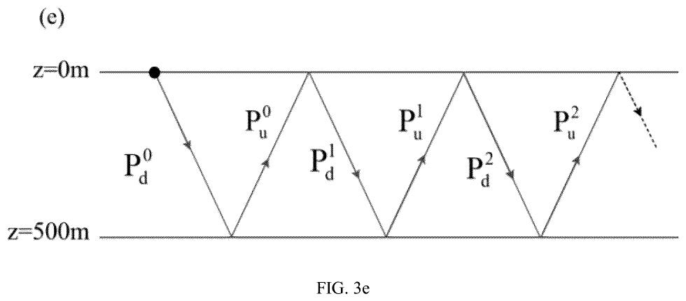

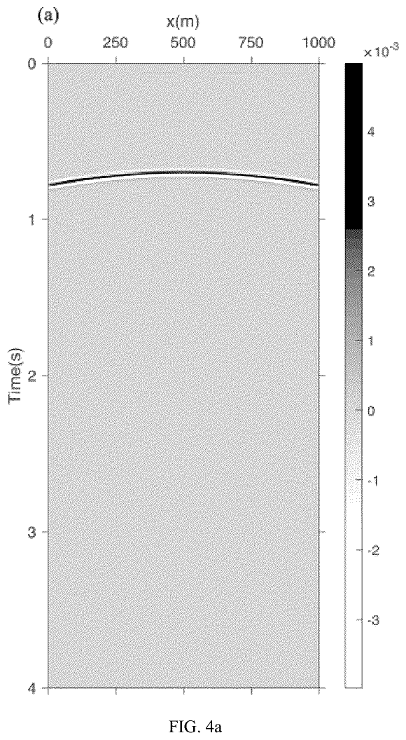

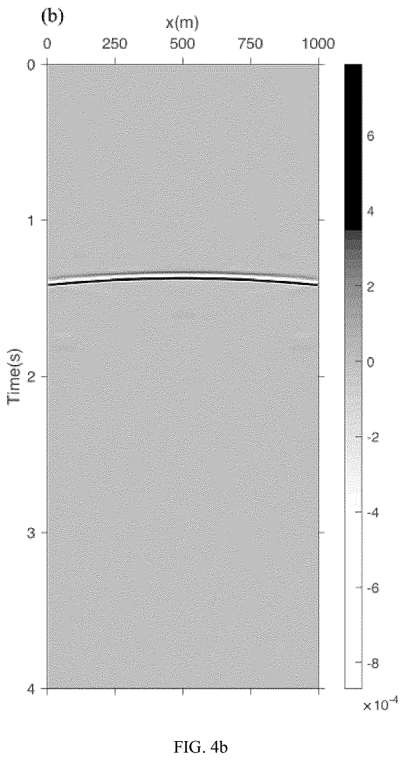

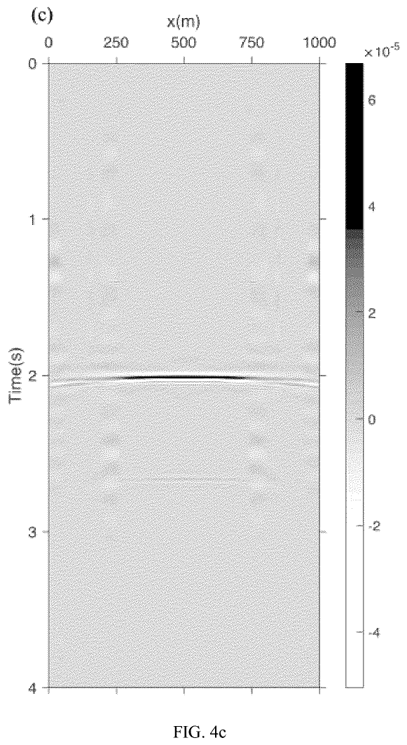

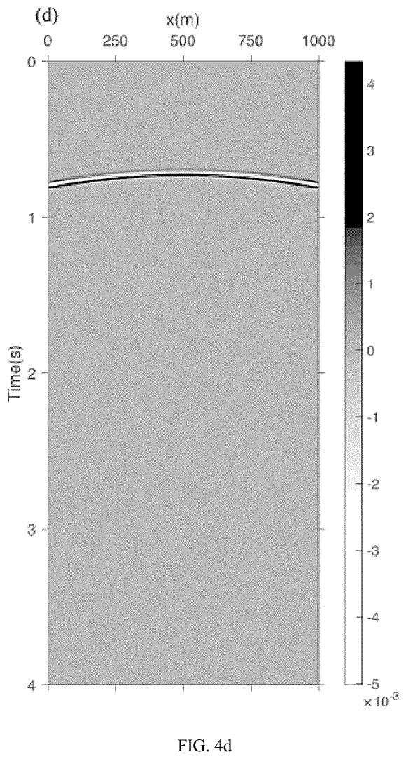

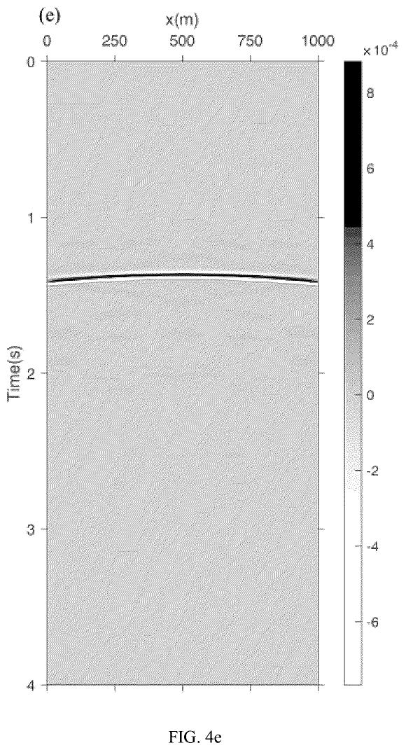

The simulated shot gather (p,q) and shot gather (pᵤ,q_{d}) (obtained after conducting the up-going/down-going wave field separation using the equation 5) are shown in FIG. 3(a-d). it should be noted that the shot gather (p,q) shown in FIGS. 3a and 3b is related to the two-way wave field, including the down-going wave field and the up-going wave field, as shown in FIGS. 3c and 3d respectively. The shot gather pᵤ is only composed of the upward propagating primary wave and the up-going multiple wave of different orders, while the shot gather p_{d} is only composed of the downward propagating multiple wave (seismic virtual source) of different orders. The propagation path diagrams of pᵤ and pᵤ are plotted in FIG. 3e. In order to remove are the interference of crosstalk artifacts from the imaging, the wave fields pᵤp_{d} further decomposed into the up-going wave field and the down-going wave field of different orders by generalized the up-going wave field and the down-going wave field separation, as shown in FIG. 4. From FIG. 4, it can be seen that the primary wave, the multiple waves of different orders and the seismic virtual source of different orders are successfully separated, which verifies the correctness and effectiveness of the generalized up-going/down-going wave field separation algorithm proposed by the present disclosure. However, it is worth noting that the amplitude of higher-order multiple waves usually decreases rapidly due to long path propagation and multiple reflections, and thus it is usually difficult to use higher-order multiple waves for imaging in practice. So the highest order N of multiple wave used for the experiment is equal to 2.

To verify the performance of the provided method in simultaneously imaging of primary wave and multiple waves of different orders, the two-way wave fields (pᵢ,qᵢ, i=1, 2, . . . , N) are reconstructed (combined) from the separated one-travel wave counterparts (pᵤⁱ⁻¹,q_{d}ⁱ). It should be noted that when N=2: due to the use of pᵤ⁰, pᵤ¹ and pᵤ², it need to use the equation 8 at the measurement surface to form the corresponding pᵤ² and qⁱ (i=1, 2, 3).

$${p}^{i} = {p}_{d}^{i} + {p}_{u}^{i - 1} \qquad ( 33 )$$

$${q}^{i} = {p}_{d}^{i} - {p}_{u}^{i - 1} .$$

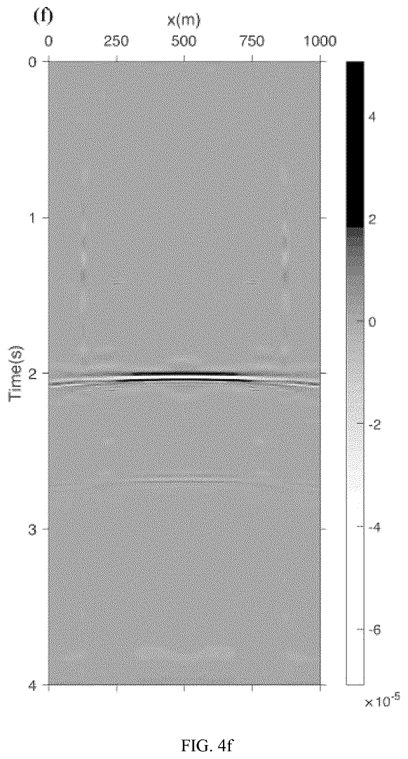

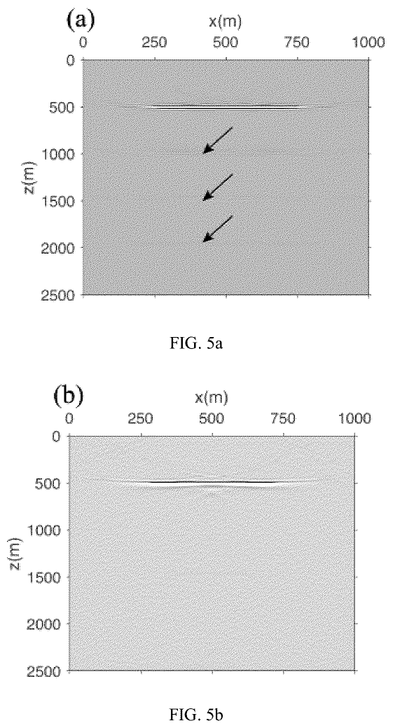

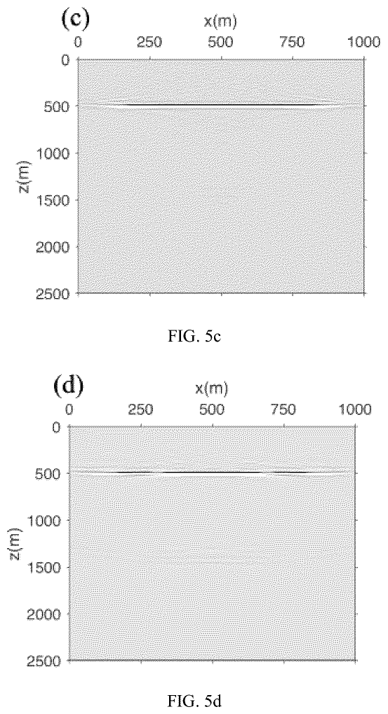

Then, at each depth extrapolation step, the same propagation matrix is used to perform depth extrapolation on the reconstructed two-way wave pressure wave fields (pⁱ,qⁱ) i=1, 2, 3). After depth extrapolation, the two-way wave fields are efficiently and decomposed into their one-way wave counterparts (pᵤ⁰, pᵤ¹ and pᵤ²) and (p_{d}¹, p_{d}² and p_{d}³). Next, applying the imaging conditions to the corresponding up-going wave fields and down-going wave fields, as shown below: primary wave imaging I₀=S*pᵤ⁰, 1-order multiple wave imaging I₁=p_{d}¹*pᵤ¹, and 2-order multiple wave imaging I₂=p_{d}²*pᵤ². It should be noted that in the two-way wave depth extrapolation scheme and multiple wave order index, in order to obtain the migration of 2-order multiple waves, the highest order of the down-going wave field is 3 (instead of 2), so p_{d}³ is necessary to construct a two-way wave field (p²,q²). The imaging results are shown in FIG. 5. As expected, the imaging results of traditional imaging using full wave field contain significant crosstalk artifacts due to strong multiple waves. These crosstalk artifacts are typically located in the deeper part of the image, as indicated by the black arrow in FIG. 5a. The imaging results of the primary wave, 1-order multiple waves, and 2-order multiple waves using the provided method are shown in FIGS. 5b, 5c, and 5d, respectively. It can be seen that compared with FIG. 5a, there has been a significant improvement in the imaging result of FIG. 5b: the interface has been correctly imaged, and all crosstalk artifacts have been successfully attenuated. In addition, compared to primary wave (FIGS. 5a and 5b), the imaging results of multiple wave (FIGS. 5c and 5d) show better illumination and wider imaging coverage (in the case, a single surface)—a typical advantage of multiple wave migration over traditional primary wave migration.

### Embodiment 5

Imaging of primary wave and multiple wave models for the Sigsbee 2B model (N=1).

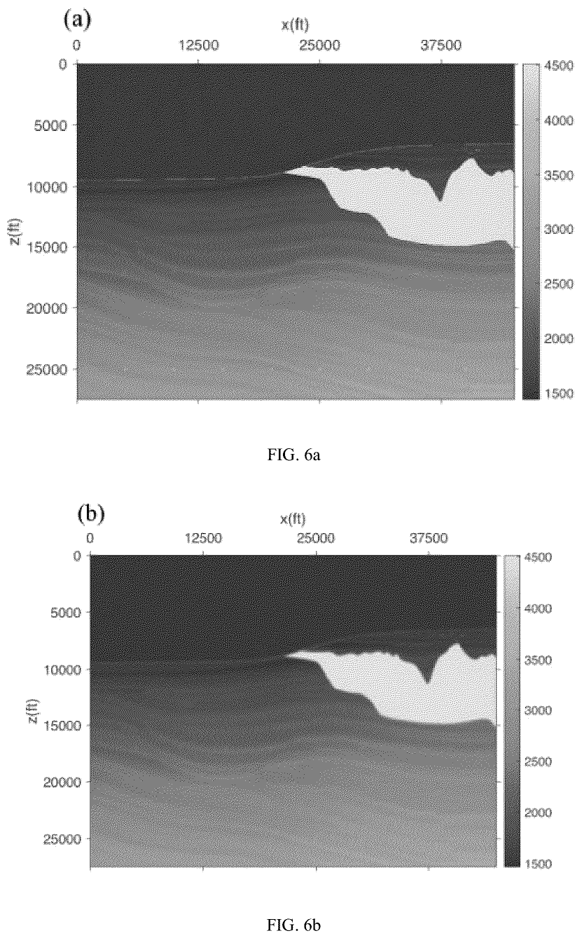

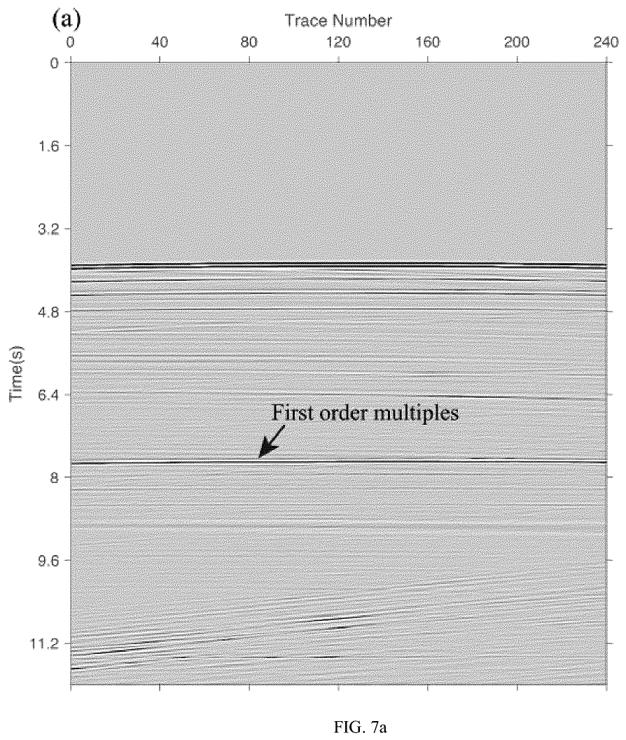

This embodiment constructs a more complex model, the Sigsbee 2B model, to further evaluate and verify the imaging quality after using the generalized wave field separation method, as well as the efficiency of using the proposed depth extrapolation scheme for simultaneous imaging of primary wave and multiple wave. The formation velocity model and its smoothed version are shown in FIGS. 6a and 6b, respectively. The original velocity model is used to generate synthesized shot gather data, while the smooth velocity model is used for imaging. The size of the model is 27, 500 fit (z)×45000 fit (x), with a spatial spacing of 25 ft in both vertical and horizontal directions. The seismic source function is a Ricker wavelet with a dominant frequency of 10 Hz. The time length of seismic records is 12 s, and the sampling rate is 0.001 s. In the numerical experiment in the section, a total of 195 shot gathers were simulated and generated, each with 240 receivers, with offset ranges ranging from −3,000 ft to 3000 ft. The interval of the seismic source and the receivers are 250 ft and 25 ft, respectively.

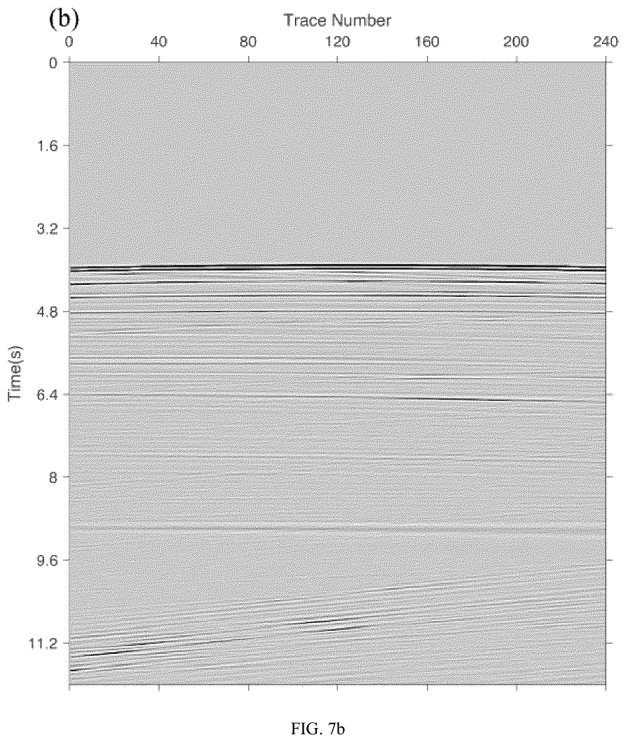

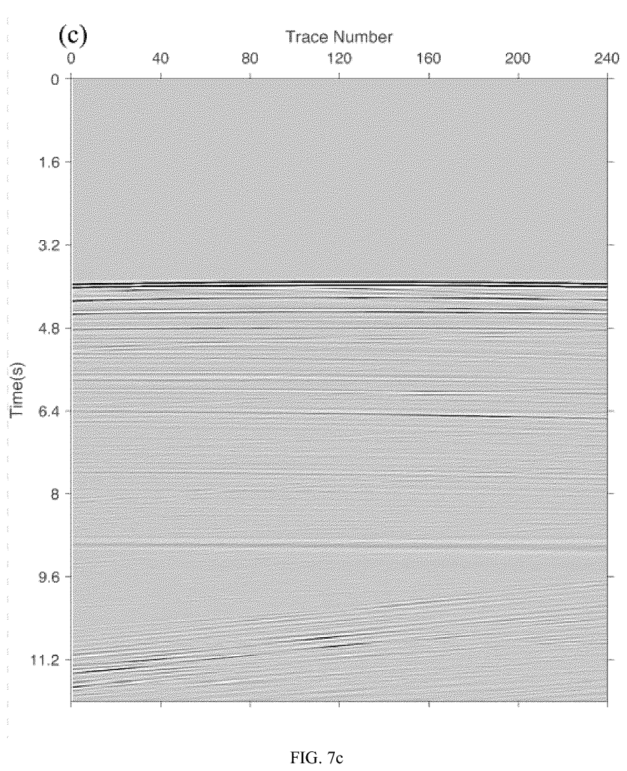

For comparison purposes, the embodiment simulates the generation of four types of shot gathers: first, a conventional shot gather with free surface multiple wave effects; second, a shot gather without free surface multiple wave effects using absorbing boundary conditions; third, a primary wave shot gather generated by the provided method; and fourth, a 1-order multiple wave shot gather generated by the provided method, as shown in FIGS. 7a, 7b, 7c, and 7d, respectively. For strong reflections from the seabed surface, even if it is located deep in the model, it can be easily observed in FIG. 7a due to its strong 1-order multiple wave (marked by black arrows). On the contrary, it can be seen that using the provided method, 1-order multiple wave were successfully eliminated in FIG. 7c (while due to the application of absorption boundaries, 1-order multiple wave were does not exist in FIG. 7b). In addition, it can be observed that the shot gather in FIG. 7c is very similar to that in FIG. 7b, which once again verifies the effectiveness and feasibility of the proposed depth imaging scheme based on multiple wave cancellation.

All shot gathers in FIG. 7 were imaged using the provided reformulated two-way wave depth extrapolation scheme.

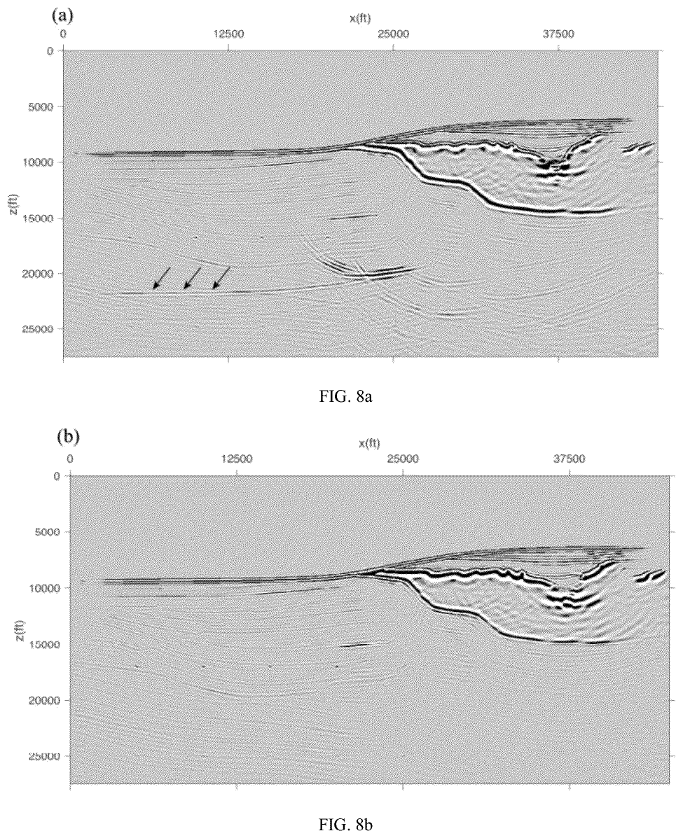

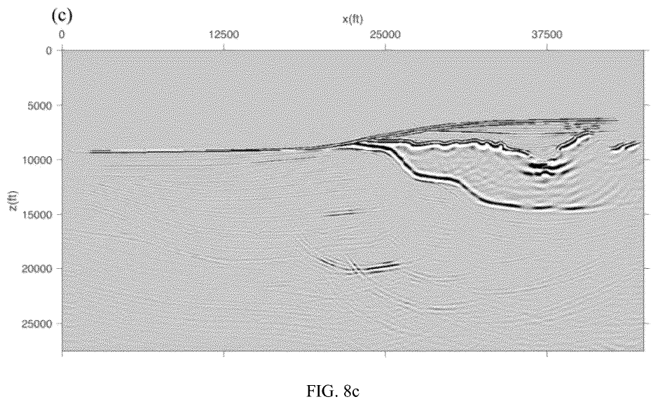

The corresponding imaging results are shown in FIG. 8. Comparing FIGS. 8a, 8b, and 8c, it can be observed that strong imaging artifacts caused by multiple wave (related to the event marked by the black arrow in FIG. 7a) are clearly present in FIG. 8a, and the proposed scheme successfully eliminates the artifacts in the imaging results of FIGS. 8b and 8c. It is also worth noting that the precise imaging of the primary wave shown in FIG. 8c is generally very similar to the imaging results with absorption boundaries applied in FIG. 8b. In addition, imaging results of 1-order multiples can also be obtained, as shown in FIG. 8d. Although the multiple wave imaging here does not introduce significant illumination enhancement and wider underground coverage for the Sigsbee 2B model, it can still provide some supplementary information for primary wave imaging in seismic interpretation.

Finally, it is worth noting that some imaging artifacts (marked with red arrows) appear in FIGS. 8a and 8c, but are not seen in FIG. 8b. Due to the various multiple scattering waves generated by the Sigsbee 2B model (many of which are generated under salt domes), the reason for the aforementioned migration artifacts may be related to those more complex multiple waves-involving free surface and internal multiple waves, which cannot be predicted and eliminated by the method provided in the present disclosure (focusing only multiple waves on free surface).

1. A method for separation of generalized primary and multiple waves using two-way wave equation based depth extrapolation method, comprising: decomposing an up-going wave field \tilde{P}ᵤ into a primary wave \tilde{P}ᵤ⁰ and up-going multiple waves of different orders on an acquisition surface, and decomposing down-going wave field \tilde{P}_{d} into the down-going multiple waves of different orders on a seismic virtual source;
based on a separation of the up-going wave field \tilde{P}ᵤ and the down-going wave field \tilde{P}_{d}, applying a two-way wave equation based wave field depth extrapolation method of for simultaneous depth extrapolation and imaging of primary waves and multiple waves of different orders to avoid crosstalk noise in imaging.

2. The method for separation of generalized primary and multiple waves using two-way wave equation based depth extrapolation method according to claim 1, wherein:
the two-way wave equation based wave field depth extrapolation method is as follows:
in a frequency space domain, a two-dimensional acoustic wave equation is expressed as:
$$( \frac{{\partial }^{2}}{\partial {x}^{2}} + \frac{{\partial }^{2}}{\partial {z}^{2}} + \frac{{ω}^{2}}{{v}^{2} ( x , z )} ) \tilde{p} ( x , z , ω ) = 0 \qquad ( 1 )$$
wherein, \tilde{p}(x, [symbol] ,ω) denotes a pressure wave field, ω denotes angular frequency, x and [symbol] denote horizontal spatial coordinates and vertical spatial coordinates, respectively; and ν(x, [symbol] ) denotes a two-dimensional velocity model;
defining and applying two boundary conditions defined at an initial depth [symbol] = [symbol] ₀; usually using \tilde{p}(x, [symbol] ,ω) and derivatives \tilde{p} [symbol] (x, [symbol] ,ω) as boundary conditions for the equation (1); and a two-way wave equation based depth extrapolation scheme from the [symbol] = [symbol] ₀ is expressed in a matrix-vector form as following:
$$[ \begin{matrix}\tilde{p} ( x , z + Δ z , ω ) \\ {\tilde{p}}_{𝓏} ( x , z + Δ z , ω )\end{matrix} ] = [ \begin{matrix}cos ( {k}_{z} Δ z ) & \frac{sin ( {k}_{z} Δ z )}{{k}_{z}} \\ - {k}_{z} sin ( {k}_{z} Δ z ) & cos ( {k}_{z} Δ z ) {k}_{z}\end{matrix} ] [ \begin{matrix}\tilde{p} ( x , z , ω ) \\ {\tilde{p}}_{z} ( x , z , ω )\end{matrix} ] \qquad ( 2 )$$
wherein,
$${k}_{z} = \sqrt{\frac{{\partial }^{2}}{\partial {x}^{2}} + \frac{{ω}^{2}}{{v}^{2} ( x )}}$$
represents a vertical wavenumber, [symbol] represents a depth, and Δ [symbol] represents an extrapolation depth;
introducing a pressure wave field \tilde{q}(x, [symbol] ,ω) to replace a pressure wave field derivative in the equation (2); a definition of parameters \tilde{q}(x, [symbol] ,ω) is:
$$\tilde{q} ( x , z , ω ) = \frac{\tilde{p} ( x , z , ω )}{{Ik}_{z}} \qquad ( 3 )$$
in the equation (3), I is an imaginary unit; in addition, in actual multi-component data acquisition system, a vertical component of velocity ν [symbol] (x, [symbol] ,ω) is usually able to be recorded, based on the vertical component of velocity, the following formula is used to calculate the wave field \tilde{q}(x, [symbol] ,ω):
$$\tilde{q} ( x , z , ω ) = ρ \frac{ω}{{k}_{z}} {v}_{z} ( x , z , ω ) \qquad ( 4 )$$
wherein, ρ is medium density;
the matrix-vector form in the equation (2) is able to be reformatted as follows:
$$[ \begin{matrix}\tilde{p} ( x , z + Δ z , ω ) \\ \tilde{q} ( x , z + Δ z , ω )\end{matrix} ] = [ \begin{matrix}cos y & I sin y \\ I sin y & cos y\end{matrix} ] [ \begin{matrix}\tilde{p} ( x , z , ω ) \\ \tilde{q} ( x , z , ω )\end{matrix} ] \qquad ( 5 )$$
I is an imaginary unit; compared with the equation (2), the reformatted matrix-vector scheme in the equation (5) makes the separation of the up-going wave field and the down-going wave field easier, and is capable of being efficiently calculated through addition and subtraction;
$${\tilde{p}}_{d} ( x , z , ω ) = \frac{1}{2} ( \tilde{p} ( x , z , ω ) + \tilde{q} ( x , z , ω ) ) \qquad ( 6 )$$
$${\tilde{p}}_{u} ( x , z , ω ) = \frac{1}{2} ( \tilde{p} ( x , z , ω ) - \tilde{q} ( x , z , ω ) )$$
wherein, \tilde{p}ᵤ(x, [symbol] ,ω) and \tilde{p}_{d}(x, [symbol] ,ω) respectively represent the up-going wave field and the down-going wave field;
thus, dual pressure wave fields \tilde{p}(x, [symbol] ,ω) and \tilde{q}(x, [symbol] ,ω) are able to be efficiently completed through calculations similar to the equation (6), as follows:
$$\tilde{p} ( x , z , ω ) = {\tilde{p}}_{d} ( x , z , ω ) + {\tilde{p}}_{u} ( x , z , ω ) \qquad ( 7 )$$
$$\tilde{q} ( x , z , ω ) = {\tilde{p}}_{d} ( x , z , ω ) - {\tilde{p}}_{u} ( x , z , ω ) .$$

3. The method for separation of generalized primary and multiple waves using two-way wave equation based depth extrapolation method according to claim 2, wherein:
the method is as following:
according to propagation geometric patterns of the primary and multiple waves, a total wave field consists of two components: a downward propagating source wave field \tilde{P}_{d} and an upward propagating receiver wave field \tilde{P}ᵤ, namely a total down-going wave field and a total up-going wave field, expressed as following:
$${\tilde{p}}_{d} = {\tilde{p}}_{d}^{0} + {\underbrace{{\tilde{p}}_{d}^{1} + {\tilde{p}}_{d}^{2} + … + {\tilde{p}}_{d}^{N}}}_{D} \qquad ( 8 )$$
$${\tilde{p}}_{u} = {\tilde{p}}_{u}^{0} + {\underbrace{{\tilde{p}}_{u}^{1} + {\tilde{p}}_{u}^{2} + … + {\tilde{p}}_{u}^{N}}}_{M} \qquad ( 9 )$$
as a generalized source, the down-going wave field comprises two types of sources: physical seismic source \tilde{P}_{d}⁰ (or S) and seismic virtual source D; the up-going wave field comprises a primary wave \tilde{P}ᵤ⁰ and a multiple wave M; \tilde{P}_{d}ⁱ and \tilde{P}ᵤⁱ denote the i-order down-going wave field and the i-order up-going wave field, respectively, wherein the order of the multiple waves i=1, 2, . . . , N; N is the order of the multiple waves;
it is obtained from the equation (8) and the equation (9) that:
$${\tilde{p}}_{d} = S + D \qquad ( 10 )$$
$${\tilde{p}}_{u} = {\tilde{p}}_{u}^{0} + M \qquad ( 11 )$$
wherein:
$$D = {\tilde{p}}_{d}^{1} + {\tilde{p}}_{d}^{2} + … + {\tilde{p}}_{d}^{N} \qquad ( 12 )$$
$$M = {\tilde{p}}_{u}^{1} + {\tilde{p}}_{u}^{2} + … + {\tilde{p}}_{u}^{N} \qquad ( 13 )$$
wherein, S is a physical seismic source \tilde{P}_{d}⁰, D is the total down-going wavefields of different order, and M is the total up-going wavefields of different order;
if cross-correction imaging conditions are directly applied to the up-going wave field and down-going wave field, the obtained imaging not only contains true migration information required, but also unwanted crosstalk noise;
$${\sum }_{ω} {\tilde{p}}_{d} {\tilde{p}}_{u} = {\sum }_{ω} {\tilde{p}}_{d}^{i} {\tilde{p}}_{u}^{i} + {\sum }_{ω} {\tilde{p}}_{d}^{i} {\tilde{p}}_{u}^{j} ( i , j = 1.2 . ⋯ , N ( i \neq j ) ) \qquad ( 14 )$$
wherein, the first term and the second term of the equation on the right correspond to the true migration imaging results and the crosstalk noise imaging results, respectively.

4. The method for separation of generalized primary and multiple waves using two-way wave equation-based depth extrapolation method according to claim 3, wherein:
decomposing the up-going wave field \tilde{P}ᵤ and the down-going wave field \tilde{P}_{d} into the multiple waves of different orders, assuming that the seismic source wave field \tilde{P}_{d}⁰(S) is known, and following up-down separation, applying two pressure parameters \tilde{p} and \tilde{q} or equivalent the up-going wave field \tilde{P}ᵤ and the down-going wave field \tilde{P}_{d};
wherein, the separation of the up-going wave field \tilde{P}ᵤ starts from the relationship between the source S, the earth response G, and the multiple waves D reflected from the sea surface:
$${\tilde{p}}_{u} = G \cdot {\tilde{p}}_{d} = G ( S + D ) = {\tilde{p}}_{u}^{0} + M \qquad ( 15 )$$
wherein:
$${\tilde{p}}_{u}^{0} = G \cdot S \qquad ( 16 )$$
$$M = G \cdot D \qquad ( 17 )$$
from the equations (12), (13), and (17), it is concluded that:
$${\tilde{p}}_{u}^{i} = G \cdot {\tilde{p}}_{d}^{i} ( i \geq 1 ) \qquad ( 18 )$$
G is the earth response, as seen from equations 15-18, G is represented by one of the following four equations:
$$G = \frac{{\tilde{p}}_{u}}{{\tilde{p}}_{d}} , G = \frac{{\tilde{p}}_{u}^{0}}{{\tilde{p}}_{d}^{0}} , G = \frac{M}{D} , or G = \frac{{\tilde{p}}_{u}^{i}}{{\tilde{p}}_{d}^{i}} ( i \geq 1 ) \qquad ( 19 )$$
using the first formula of the equation (19) and the equation (16), the relationship between \tilde{p}ᵤ⁰ and \tilde{p}ᵤ is obtained as follows:
$$G = \frac{{\tilde{p}}_{u}}{S + D} = \frac{{\tilde{p}}_{u}}{S ( 1 + \frac{D}{S} )} \qquad ( 20 )$$
$${\tilde{p}}_{u}^{0} = G \cdot S = \frac{{\tilde{p}}_{u}}{1 + \frac{D}{S}} - \frac{{\tilde{p}}_{u}}{1 + {D}^{′}} \qquad ( 21 )$$
wherein:
$${D}^{′} = \frac{D}{S} = A \cdot D \qquad ( 22 )$$
$$A = \frac{1}{S} \qquad ( 23 )$$
D′ mentioned above denotes the down-going wave after deconvolution, and A denotes source characteristics in a frequency domain.

5. The method for separation of generalized primary and multiple waves using two-way wave equation depth extrapolation method according to claim 4, wherein:
in order to decompose the up-going wave field into primary waves and the up-going multiple waves of different orders, the right side of the equation (21) is expanded in series:
$${\tilde{p}}_{u}^{0} = {\tilde{p}}_{u} - {D}^{′} \cdot {\tilde{p}}_{u} + {D}^{′2} \cdot {\tilde{p}}_{u} + … + {( - 1 )}^{N} {D}^{′ N} \cdot {\tilde{p}}_{u} \qquad ( 24 )$$
$$M = {\tilde{p}}_{u} - {\tilde{p}}_{u}^{0} = {D}^{′} \cdot {\tilde{p}}_{u} - {D}^{′2} \cdot {\tilde{p}}_{u} + … + {( - 1 )}^{N - 1} {D}^{′ N} \cdot {\tilde{p}}_{u} \qquad ( 25 )$$
wherein, N is the order of multiple waves;
the relationship between \tilde{P}ᵤ and \tilde{P}ᵤ⁰ expressed in the equations (24) and (25) is proven to be equivalent to other methods derived solely from the up-going wave field \tilde{P}ᵤ;
the main advantage of using two boundary conditions applied to the acquisition surface is that, a free surface reflection operator is not required, which is implicit in the decomposition of the up-going wave field and the down-going wave field;
simplifying the equation (25) above to obtain:
$$M = {C}_{1} + {C}_{2} + {C}_{3} + … + {C}_{i} \qquad ( 26 )$$
wherein: C₁, . . . , Cᵢ corresponds to each term on the far right of the equation (25), namely:
$${C}_{1} = {D}^{′} \cdot {\tilde{p}}_{u} , {C}_{2} = {D}^{′2} \cdot {\tilde{p}}_{u} , {C}_{3} = {D}^{′3} \cdot {\tilde{p}}_{u} , … , {C}_{i} = {( - 1 )}^{N - 1} {D}^{′ N} \cdot {\tilde{p}}_{u}$$
wherein, the separation of the down-going wave field \tilde{P}_{d};
once \tilde{P}ᵤ decomposed into primary waves and up-going multiple waves of different orders, the down-going wave field is correspondingly decomposed into a plurality of virtual seismic sources;
using the equations (20) and (26), the first-order down-going wave field and the higher-order down-going wave field are obtained as follows:
$$\begin{matrix}{\tilde{p}}_{d}^{1} = \frac{{\tilde{p}}_{d}}{1 + {D}^{′}} \\ = {\tilde{p}}_{d} - [ {D}^{′} \cdot {\tilde{p}}_{d} - {D}^{′2} \cdot {\tilde{p}}_{d} + {D}^{′3} \cdot {\tilde{p}}_{d} + … {( - 1 )}^{N - 1} {D}^{′ N} \cdot {\tilde{p}}_{d} ] \\ = {\tilde{p}}_{d} - ( {K}_{1} + {K}_{2} + {K}_{3} + … + {K}_{i} )\end{matrix} \qquad ( 28 )$$
wherein: K₁, . . . , Kᵢ corresponds to each term on the right side of the second row of the equation (28), namely:
$${K}_{1} = {D}^{′} \cdot {\tilde{p}}_{u} , {K}_{2} = - {D}^{′2} \cdot {\tilde{p}}_{u} , {K}_{3} = {D}^{′3} \cdot {\tilde{p}}_{u} , … , {K}_{i} = {( - 1 )}^{N - 1} {D}^{′ N} \cdot {\tilde{p}}_{u} \qquad ( 29 )$$
the down-going wave field is decomposed into \tilde{P}_{d}ⁱ (i=1, 2, . . . , N) expressed as: Kᵢ (i=1, 2, . . . , N); for N=3, the relationship between \tilde{P}_{d}ⁱ and Kᵢ is as follows:
$${\tilde{p}}_{d}^{1} = {K}_{1} + 2 {K}_{2} + 3 {K}_{3} , \qquad ( 30 )$$
$${\tilde{p}}_{d}^{2} = - {K}_{2} - 3 {K}_{3} ,$$
$${\tilde{p}}_{d}^{3} = {K}_{3}$$
using the equation (30), the calculation of \tilde{P}_{d}², \tilde{P}_{d}³ and \tilde{P}_{d}⁴ is completed through simple operations of K₁, K₂ and K₃, while the values of K₁, K₂ and K₃ are obtained from the equations (28) and (29);
based on above process, the up-going wave field is decomposed into primary waves and up-going multiple waves of different orders, and the down-going wave field is decomposed into virtual seismic sources of different orders.

6. A method for imaging of generalized primary and multiple waves using two-way wave equation depth extrapolation method according to claim 2, wherein:
the method for separation of the generalized primary and multiple waves is capable to simultaneously achieve imaging of primary waves and multiple waves of different orders with very limited computational cost and high efficiency, and this method includes four steps:
reconstruction, extrapolation, separation, and imaging.

7. The method for imaging of generalized primary and multiple waves using two-way wave equation depth extrapolation method according to claim 6, wherein:
the reconstruction is as follows:
reconstructing data into a two-way wave pressure wave fields (\tilde{p}ᵢ,\tilde{q}ᵢ),
firstly, recombining and reconstructing the separated up-going wave field and the down-going wave field: using the equation (6) to reconstruct \acute{p}_{d}ⁱ (i=1, 2, . . . , N+1) and \tilde{p}ᵤⁱ (i=1, 2, . . . , N) into the relevant two-way wave pressure wave fields \tilde{p}ᵢ,\tilde{q}ᵢ (i=1, 2, . . . , N) on the acquisition surface:
$${\tilde{p}}_{i} = {\tilde{p}}_{d}^{i} + {\tilde{p}}_{u}^{i - 1} \qquad ( 31 )$$
$${\tilde{q}}_{i} = {\tilde{p}}_{d}^{i} - {\tilde{p}}_{u}^{i - 1} ( i = 1 , 2 , … , N + 1 ) .$$

8. The method for imaging of generalized primary and multiple waves using two-way wave equation depth extrapolation method according to claim 6, wherein:
extrapolation of primary waves and multiple waves of different orders (\tilde{p}ⱼ,\tilde{q}ⱼ);
the two-way wave pressure wave fields (\acute{p}ᵢ,\tilde{q}ᵢ) (i=1, 2, . . . , N+1) after reconstruction is conducted depth extrapolation using the same two-way wave propagation matrix (as described in equation 4), wherein the one-dimensional vectors \tilde{p} and \tilde{q} in equation 4 are extended into multidimensional vectors (matrices): (\tilde{p}ⱼ,\tilde{q}ⱼ), wherein j=1, 2, . . . , N+1;
the extended matrix-vector form is represented as follows:
$$[ \begin{matrix}{\tilde{p}}_{1} ( x , z + Δ z , ω ) & … {\tilde{p}}_{j} ( x , z + Δ z , ω ) … & {\tilde{p}}_{N} ( x , z + Δ z , ω ) \\ {\tilde{q}}_{1} ( x , z + Δ z , ω ) & … {\tilde{q}}_{j} ( x , z + Δ z , ω ) … & {\tilde{q}}_{N} ( x , z + Δ z , ω )\end{matrix} ] = [ \begin{matrix}cos y & I sin y \\ I sin y & cos y\end{matrix} ] [ \begin{matrix}{\tilde{p}}_{1} ( x , z , ω ) & … {\tilde{p}}_{j} ( x , z , ω ) … & {\tilde{p}}_{N} ( x , z , ω ) \\ {\tilde{q}}_{1} ( x , z , ω ) & … {\tilde{q}}_{j} ( x , z , ω ) … & {\tilde{q}}_{N} ( x , z , ω )\end{matrix} ] \qquad ( 32 )$$
in the equation (32), I is an imaginary unit;
according to the exponential definition of \tilde{p}ᵤ and \tilde{p}_{d}, in the case of j=1, the depth extrapolation of the two-way wave pressure wave fields (\tilde{p}₁,\tilde{q}₁) is a conventional method of depth extrapolation; and due to the fact that the calculation of the two-way wave propagation matrix accounts for the largest proportion of the computational cost in depth extrapolation, the additional computational cost of matrix-vectors for multiple waves (j=1, 2, . . . , N) is limited.

9. The method for imaging of generalized primary and multiple waves based on depth extrapolation method of two-way wave equation according to claim 6, wherein:
the separation is as follows:
decomposing the two-way wave pressure wave fields (\tilde{p}ᵢ,\tilde{q}ᵢ) into primary waves and multiple waves of different orders in each depth extrapolation step; using the equation (5) to decompose the two-way wave pressure wave field (\tilde{p}ᵢ,\tilde{q}ᵢ) (i=1, 2, . . . , N+1) (i=1, 2, . . . , N+1) after depth extrapolation into:
$${\tilde{p}}_{d}^{i} = \frac{1}{2} ( {\tilde{p}}_{j} + {\tilde{q}}_{j} ) \qquad ( 33 )$$
$${\tilde{p}}_{u}^{i - 1} = \frac{1}{2} ( {\tilde{p}}_{i} - {\tilde{q}}_{i} ) ( i = 1 , 2 , … , N + 1 )$$
the separation of the up-going wave field/the down-going wave field represented by equation 31 is very efficient, only simple summation and subtraction operations are required, so the additional calculations involved in this processing process (involving multidimensional vectors) are capable of being ignored.

10. The method for imaging of generalized primary and multiple waves using two-way wave equation depth extrapolation method according to claim 6, wherein:
imaging of the primary wave and the multiple waves of different orders
using the decomposed (\tilde{p}_{d}ⁱ, \tilde{p}ᵤⁱ⁻¹) (i=1, 2, . . . , N+1) for imaging of primary wave and multiple waves in a controllable manner:
$${I}_{0} = S * {\tilde{p}}_{u}^{0} \qquad ( 34 )$$
$${I}_{i} = {\tilde{p}}_{d}^{1} * {\tilde{p}}_{u}^{1} ( i = 1 , 2 , … , N )$$
$${I}_{m} = {\sum }_{i} {I}_{i} ( i = 1 , 2 , … , N )$$
wherein “*” represents cross-correlation operation (time domain) or multiplication operation (frequency domain); S represents physical seismic source; I₀ is the imaging of the primary wave, similar to traditional imaging, which requires conducting the source wave field extrapolation; Iᵢ the imaging of multiple waves of different orders; and Iₘ is an imaging of a total of N-order multiple waves.
